(19) United States
(12) Patent Application Publication
(10) Pub. No.: US 2005/0253568 A1
(43) Pub. Date: Nov. 17, 2005

(54) Switching regulator control circuit and switching regulator

(76) Inventor: Shigeyuki Morimoto, Chiba-shi (JP)

Correspondence Address: BRUCE L. ADAMS, ESQ., 31ST FLOOR, 50 BROADWAY, NEW YORK, NY, 10004, US

(21) Appl. No.: 11/126,635

(22) Filed: May 11, 2005

(30) Foreign Application Priority Data
May 12, 2004 (JP) 2004-141938

(51) Int. Cl. G05F 1/40

(52) U.S. Cl. 323/282

(57) ABSTRACT

The present invention provides a switching regulator control circuit which includes low voltage operation stopping circuits different in operating voltage from each other and which is capable of obtaining a stable output voltage even when an input voltage slowly increases from a low voltage. A release delay time is set in a low voltage operation stopping circuit adapted to operate at a low voltage, whereby after a low voltage operation stopping circuit adapted to operate at a high voltage outputs a detection signal, the low voltage operation stopping circuit adapted to operate at the low voltage outputs a release signal.

### BACKGROUND OF THE INVENTION

1. Field of the Invention

The present invention relates to a switching regulator control circuit capable of stopping a switching operation to avoid malfunction when an input power supply voltage in activation or in operation is low.

2. Related Background Art

FIG. 3 shows a conventional switching regulator. The conventional switching regulator includes: an inductor 202; a switching element 203; a rectifying element 204; a smoothing capacitor 205; an output voltage control circuit 207; an operation controlling logical circuit 208; a first low voltage operation stopping circuit (hereinafter referred to as “a UVLO1 circuit”) 209; and a second low voltage operation stopping circuit (hereinafter referred to as “a UVLO2 circuit”) 210. The UVLO1 circuit 209 and the UVLO2 circuit 210 monitor an input voltage, and send a signal to the output voltage control circuit 207 through the operation controlling logical circuit 208 to stop the switching operation when the input voltage is low and thus a normal switching operation can not be carried out.

In the UVLO1 circuit 209, an input voltage VIN is attenuated through an attenuator 211, and the resultant input voltage is compared with a voltage from a reference voltage source 212 in a comparator 213. When the input voltage VIN becomes equal to or lower than a known detection voltage VIN1, the comparator 213 outputs a Hi signal. On the other hand, when the input voltage VIN becomes equal to or higher than a known release voltage, the comparator 213 outputs a Lo signal. In general, in order to remove noises contained in the input voltage, the detection voltage and the release voltage are set so as to be different from each other by giving the voltage detection hysteresis. In this case, when the release voltage is larger than the detection voltage, the voltage detection is given several ten to several hundred mV of the hysteresis.

When the output signal from the comparator 213 is changed from the Lo signal to the Hi signal, the output signal thereof is transmitted to the operation controlling logical circuit 208 after being delayed by a fixed period of time by a detection delay circuit 214. When the input voltage VIN instantaneously becomes lower than the detection voltage VIN1 due to noises, the detection delay circuit 214 acts as a filter for removing the noises to prevent malfunction.

In addition, in order to cause the reference voltage source 212 and the comparator 213 to normally operate, the UVLO1 circuit 209 operates in a voltage range in which the input voltage VIN is equal to or higher than a predetermined input voltage, e.g., 2 V. Thus, the detection voltage of the UVLO1 circuit 209 is set in the above-mentioned input voltage range (it is set to 2 V for example).

When a low voltage detection circuit 215 shows that the input voltage VIN becomes equal to or lower than a known detection voltage, the UVLO2 circuit 210 outputs a Hi signal. On the other hand, when the input voltage VIN becomes equal to or higher than a known release voltage, the UVLO2 circuit 210 outputs a Lo signal. In general, the known detection voltage and the release voltage are different from each other similarly to the case of the UVLO1 circuit 209 since the voltage detection may be given the hysteresis. However, since the UVLO2 circuit 210 is configured with a simple circuit configuration in many cases, actually, the detection voltage may be equal to the release voltage without the hysteresis. The UVLO2 circuit 210 is configured in the form of a circuit block which can operate at such a low input voltage as to be equal to or higher than 1 V for example, by changing a target value in a circuit design. In this case, the release voltage of the UVLO2 circuit 210 is set in the above-mentioned input voltage range (1 V for example).

Here, the detection voltage of the UVLO1 circuit 209 is set higher than the release voltage of the UVLO2 circuit 210. When the detection voltage of the UVLO1 circuit 209 is DV1, the release voltage thereof is RV1, and the detection voltage of the UVLO2 circuit 210 is DV2, the release voltage thereof is RV2, a relationship of DV2<RV2<DV1<RV1 is obtained.

When the input voltage VIN quickly increases from the low voltage in activation or in operation, firstly, the UVLO2 circuit 210 falls its operation within the operation range and transmits the Hi signal for detecting that the voltage is low, and in this state, the UVLO1 circuit 209, falls its operation within the operation range and transmits the Hi signal for detecting that the voltage is low. Thereafter, when the input voltage VIN increases to reach the release voltage, the output of the UVLO2 circuit 210 is changed from the Hi signal to the Lo signal. For the above-mentioned voltage period of time, one of the UVLO1 circuit 209 and the UVLO2 circuit 210 operates and monitors the input voltage VIN (refer to JP 2000-75940 A for example).

However, the conventional switching regulator involves a problem in that since the detection delay circuit 214 is provided in the UVLO1 circuit 209, when the input voltage VIN gradually increases from the low voltage in activation or in operation, even if the input voltage VIN exceeds the release voltage of the UVLO2 circuit 210, the detection delay time prohibits the UVLO1 circuit 209 from outputting the detection signal, and the malfunction is caused in the output voltage control circuit 207 to make the output voltage unstable.

FIG. 4 is a time chart for explaining an operation of the conventional switching regulator control circuit in the unstable state. When the input voltage VIN is applied at a time point A to gradually increase, firstly, the UVLO2 circuit 210 operates to output the Hi signal. Thereafter, when the input voltage VIN further increases to reach the release voltage of the UVLO2 circuit 210, e.g. 1 V, at a time point B, the output of the UVLO2 circuit 210 is changed from the Hi signal to the Lo signal to release the malfunction preventing function.

On the other hand, since the UVLO1 circuit 209 outputs no detection signal, for a period of time until a time point C at which the UVLO1 circuit 201 outputs the Hi signal after a lapse of a predetermined time set by the detection delay circuit 214 after the comparator 213 detects the detection voltage, the control circuit 207 outputs an output signal EXT. Thus, the switching element 203 is driven, and an output voltage VOUT supplied to an apparatus 206 becomes unstable. Hence, in FIG. 4, the signals at Hi from the UVLO1 circuit 209 and the UVLO2 circuit 210 gradually increase because of the leading process of the input voltage VIN

### SUMMARY OF THE INVENTION

In order to solve the above-mentioned problems, a switching regulator control circuit of the present invention includes: a first low voltage operation stopping circuit for detecting a first voltage value of an input voltage; and a second low voltage operation stopping circuit for detecting a second voltage value of -the input voltage smaller than the first voltage value detected by the first low voltage operation stopping circuit, the switching regulator control circuit serving to stop an operation based on the first and second voltage values detected by the first and second low voltage operation stopping circuits, respectively, in which: the first low voltage operation stopping circuit detects a predetermined voltage value of the input voltage to output a first release signal; the second low voltage operation stopping circuit detects a voltage value smaller than the predetermined voltage value to output a second release signal; and the second release signal is outputted after the first low voltage operation stopping circuit operates.

According to the switching regulator control circuit of the present invention as described above, it is possible to realize the switching regulator, which can carry out the normal switching operation in any case irrespective of the change in the input voltage value.

### BRIEF DESCRIPTION OF THE DRAWINGS

In the accompanying drawings:

FIG. 1 is a circuit diagram of a switching regulator control circuit according to an embodiment of the present invention;

FIG. 2 is a time chart for explaining an operation of the switching regulator control circuit according to the embodiment of the present invention;

FIG. 3 is a circuit diagram of a conventional switching regulator control circuit;

FIG. 4 is a time chart for explaining an operation of the conventional switching regulator control circuit; and

FIG. 5 is a circuit diagram, partly in block diagram, showing an example of a release delay circuit in the switching regulator control circuit according to the embodiment of the present invention.

### DESCRIPTION OF THE PREFERRED EMBODIMENTS

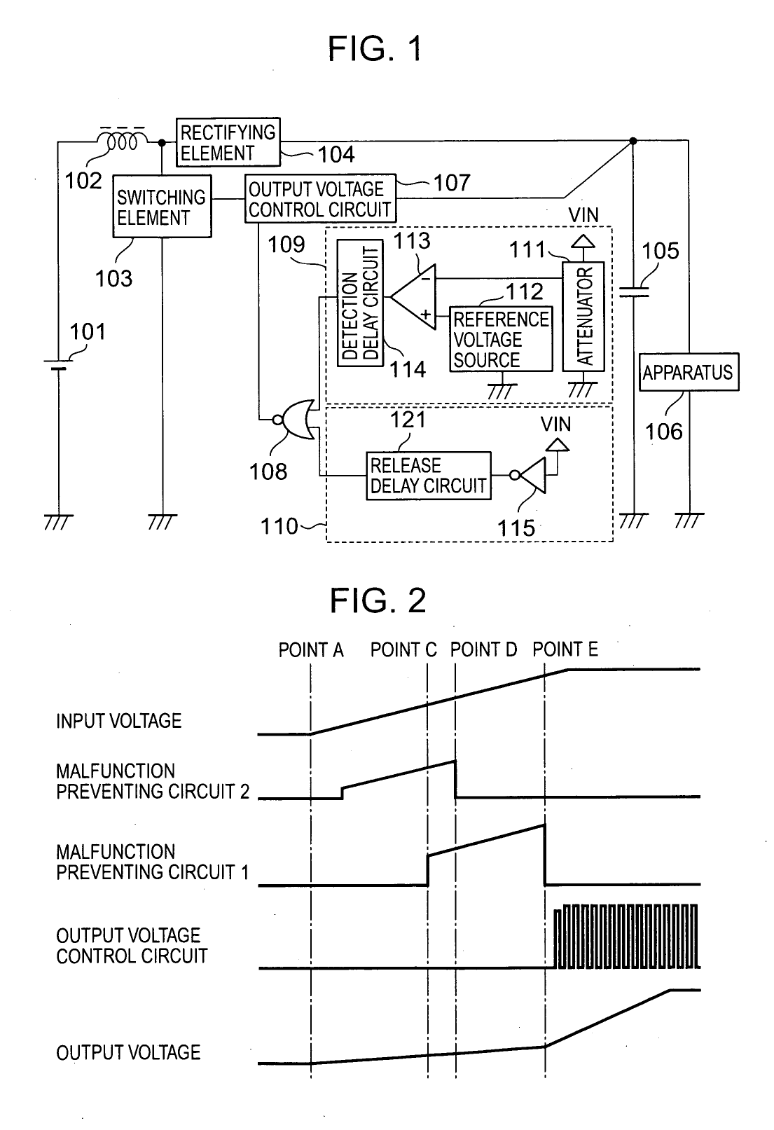

The present invention will hereinafter be described with reference to the accompanying drawings. FIG. 1 shows a switching regulator control circuit according to an embodiment of the present invention.

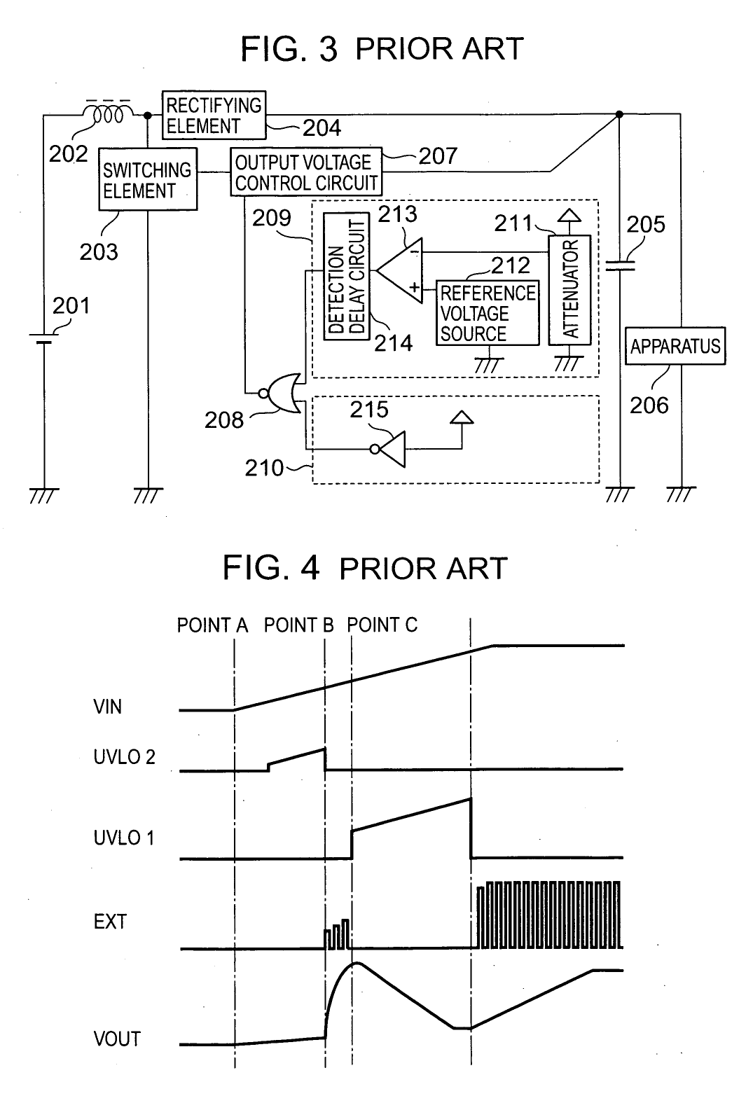

An inductor 102, a switching element 103, a rectifying element 104, a smoothing capacitor 105, an output voltage control circuit 107, an operation controlling logical circuit 108, and a UVLO1 circuit 109 are the same in structure as the inductor 202, the switching element 203, the rectifying element 204, the smoothing capacitor 205, the output voltage control circuit 207, the operation controlling logical circuit 208, and the UVLO1 circuit 209 of the conventional switching regulator control circuit shown in FIG. 3. Also, a low voltage releasing circuit 115 of a UVLO2 circuit 110 is the same in configuration as the low voltage detecting circuit 215 of the conventional example. Thus, when an input voltage VIN becomes equal to or higher than a known release voltage, the low voltage releasing circuit 115 outputs a Lo signal.

A release delay time in the UVLO2 circuit 110 is set so that the output of a release signal Lo becomes latter than the output of a detection signal Hi from the UVLO1 circuit 109. Since the detection delay time ends before the UVLO2 circuit 110 outputs the Lo signal and the UVLO1 circuit 109 outputs a Hi signal, the operation controlling logical circuit 108 leaves a switching operation of the output voltage control circuit 107 stopped.

FIG. 2 is a time chart for explaining an operation of the switching regulator control circuit according to this embodiment of the present invention, and shows a case where the input voltage VIN gradually increases from a low voltage.

Even when the input voltage VIN slowly increases from a low voltage in activation or in operation as shown in FIG. 2, the stop of the output voltage control circuit 107 is not released until a voltage is obtained at which a stable switching operation can be carried out, and thus the output voltage is prevented from becoming unstable in accordance with the operation of the switching regulator control circuit shown in FIG. 1.

The input voltage VIN is applied at a time point A in FIG. 2 and is caused to gradually increase. When the input voltage VIN reaches the release voltage of the UVLO2 circuit 110, e.g., 1 V, the low voltage releasing circuit 115 outputs a release signal Lo. This release signal Lo is outputted after the detection delay time in the UVLO1 circuit 109 ends in accordance with the operation of the release delay circuit 121 and the UVLO1 circuit 109 outputs a detection signal (at a time point C). Then, the UVLO2 circuit 110 outputs the release signal (at a time point D). As a result, since even in-the activation state of the input voltage VIN, an output signal EXT (an output signal from the output voltage control circuit 107) is not generated until the UVLO1 circuit 109 is released (at a time point E), the switching element 103 is left being off-controlled. As a result, it is possible to stabilize an output voltage VOUT (a voltage applied to an apparatus 106).

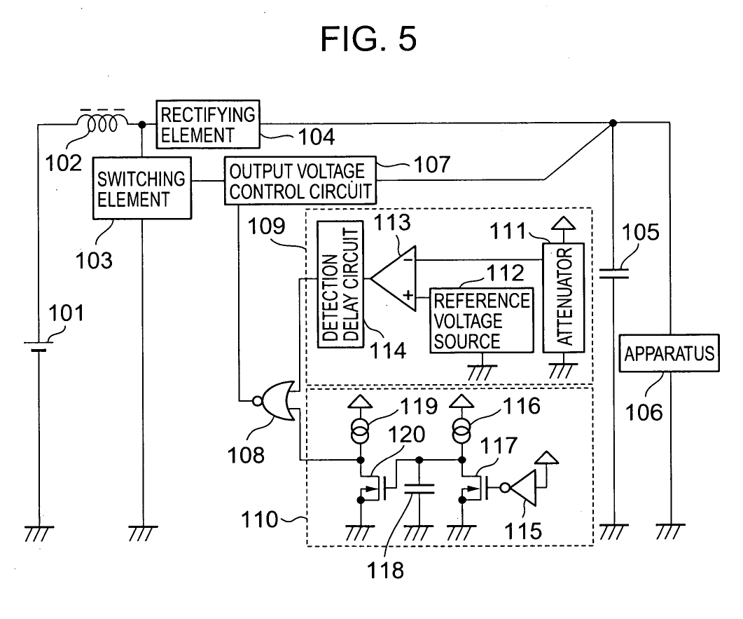

FIG. 5 is a circuit diagram showing an embodiment of the release delay circuit 121 shown in FIG. 1. As described above, when the input voltage VIN becomes equal to or higher than a known release voltage, the low voltage releasing circuit 115 outputs a Lo signal. At this time, since a transistor 117 is turned OFF, a constant current 116 charges a capacitor 118 with electricity. Thus, after a lapse of a fixed period of time, a transistor 120 is turned ON, and the UVLO2 circuit 110 outputs an output Lo signal. In this embodiment, the release delay time is mainly set depending on a capacitance value of the capacitor 118.

1. A switching regulator control circuit, comprising:
a first low voltage operation stopping circuit for detecting a first voltage value of an input voltage; and
a second low voltage operation stopping circuit for detecting a second voltage value of the input voltage smaller than the first voltage value detected by the first low voltage operation stopping circuit,
the switching regulator control circuit serving to stop an operation based on the first and second voltage values detected by the first and second low voltage operation stopping circuits, respectively,
wherein: the first low voltage operation stopping circuit detects a predetermined voltage value of the input voltage to output a first release signal;
the second low voltage operation stopping circuit detects a voltage value smaller than the predetermined voltage value to output a second release signal; and
the second release signal is outputted after the first low voltage operation stopping circuit operates.

2. A switching regulator using the switching regulator control circuit according to claim 1.
